(19) United States
(12) Patent Application Publication
(10) Pub. No.: US 2026/0299513 A1
(43) Pub. Date: Oct. 1, 2026

(54) IMAGE FORMING APPARATUS INCLUDING MAIN BODY HOUSING, PROCESS UNIT, FIXING DEVICE, EXHAUST FAN, FIRST DUCT, FILTER AND SEAL

(71) Applicant: BROTHER KOGYO KABUSHIKI KAISHA, Nagoya (JP)

(72) Inventors: Soma KATO, Nagoya (JP); Yasuhiro HOSOKAWA, Niwa (JP); Wataru YAMAGUCHI, Nisshin (JP)

(73) Assignee: BROTHER KOGYO KABUSHIKI KAISHA, Nagoya (JP)

(21) Appl. No.: 19/557,858

(22) Filed: Mar. 5, 2026

(30) Foreign Application Priority Data
Mar. 26, 2025 (JP) 2025-051882

(51) Int. Cl. G03G 21/20; B01D 46/00; B01D 46/24; B01D 53/86; G03G 15/00; G03G 21/18

(52) U.S. Cl. CPC G03G 21/206; B01D 46/0027; B01D 46/2418; B01D 53/8675; G03G 15/80; G03G 21/1814; G03G 21/1832; B01D 2257/106; B01D 2258/06

(57) ABSTRACT

An image forming apparatus includes a main body housing, a process unit, a fixing device, an exhaust fan, a first duct, a filter, and a seal. The main body housing includes a louver. The process unit includes a photosensitive drum and a developing unit. The exhaust fan is configured to exhaust air through the louver. The first duct extends in an axial direction to have an end portion. The seal is sandwiched between the end portion of the first duct and the filter in the axial direction. The seal blocks a passage between the process unit and a center of the exhaust fan when viewed in the axial direction. The seal defines an opening located in an opposite side of the center of the exhaust fan from the process unit when viewed in the axial direction.

### REFERENCE TO RELATED APPLICATIONS

This application claims priority from Japanese Patent Application No. 2025-051882 filed on Mar. 26, 2025. The entire content of the priority application is incorporated herein by reference.

### BACKGROUND ART

A known image forming apparatus includes a process unit, a fan, a duct, and a filter. The process unit is configured to form a toner image on a sheet. The fan is configured to exhaust air inside an apparatus main body of the image forming apparatus. The duct is configured to guide air exhausted from the fan to an exhaust opening formed in an exterior member constituting the apparatus main body. The filter is disposed downstream of the fan in an exhaust direction in which air is exhausted. In the image forming apparatus, the filter is configured to remove dust and the like contained in air to be exhausted by the fan.

In the known image forming apparatus, the filter is sandwiched between the duct and the exterior member and is retained between the duct and the exterior member.

### SUMMARY

In the configuration of the known image forming apparatus, in which the filter is sandwiched between the duct and the exterior member, stress is applied to the filter. In order to reduce stress applied to the filter, an elastic member can be disposed between the filter and the duct. However, in a case where the elastic member is disposed, exhaust efficiency may be reduced due to an increase of flow passage resistance caused by the filter, and the space between the fan and the filter may become excessively positively pressurized.

Since the space between the fan and the filter becomes excessively positively pressurized, air containing water vapor generated from the fixing device may leak and therefore the water vapor may flow into the process unit.

In view of the foregoing, it is an object of the present disclosure to provide an image forming apparatus capable of reducing the likelihood that air containing water vapor flows into a process unit.

In order to attain the above and other objects, according to one aspect, the present disclosure provides an image forming apparatus including a main body housing, a process unit, a fixing device, an exhaust fan, a first duct, a filter, and a seal. The main body housing includes a louver. The process unit is configured to form a toner image on a sheet. The process unit includes: a photosensitive drum configured to rotate about an axis; and a developing unit configured to supply toner to the photosensitive drum. The fixing device is configured to heat the sheet on which the toner image is formed to fix the toner image to the sheet. The exhaust fan is configured to exhaust air inside the main body housing to an outside of the main body housing through the louver. The exhaust fan is disposed inside the main body housing. The exhaust fan is positioned inward of the louver in an axial direction of the photosensitive drum. The exhaust fan is disposed at a position not overlapping the process unit when viewed in the axial direction. The first duct extends in the axial direction to have an end portion located closer to the louver in the axial direction than the exhaust fan is to the louver in the axial direction. The first duct accommodates the exhaust fan in an internal space of the first duct. The filter is disposed between the louver and the end portion of the first duct in the axial direction. The seal is formed of an elastic material. The seal is sandwiched between the end portion of the first duct and the filter in the axial direction. The seal surrounds the exhaust fan when viewed in the axial direction. The seal blocks a passage between the process unit and a center of the exhaust fan when viewed in the axial direction. The seal defines an opening located in an opposite side of the center of the exhaust fan from the process unit when viewed in the axial direction.

According to another aspect, the present disclosure also provides an image forming apparatus including a main body housing, a process unit, a fixing device, an exhaust fan, a first duct, a filter, and a seal. The main body housing includes a louver. The process unit is configured to form a toner image on a sheet. The process unit includes: a photosensitive drum configured to rotate about an axis extending in an axial direction; and a developing roller configured to supply toner to the photosensitive drum. The fixing device is configured to heat the sheet on which the toner image is formed to fix the toner image to the sheet. The exhaust fan is configured to exhaust air from an inside of the main body housing to an outside of the main body housing through the louver. The exhaust fan is disposed inside the main body housing. The exhaust fan is positioned inward of the louver in the axial direction. The exhaust fan is disposed at a position not overlapping the process unit when viewed in the axial direction. The first duct is disposed inside the main body housing. The first duct accommodates the exhaust fan in an internal space of the first duct. The first duct extends in the axial direction to have an end portion located closer to the louver in the axial direction than the exhaust fan is to the louver in the axial direction. The filter is disposed between the louver and the end portion of the first duct in the axial direction with an intermediate space formed between the filter and the end portion of the first duct in the axial direction. The intermediate space surrounds the exhaust fan when viewed in the axial direction. The seal is formed of an elastic material. The seal is sandwiched between the filter and the end portion of the first duct in the axial direction. The seal surrounds the exhaust fan when viewed in the axial direction. The seal seals at least a first portion of the intermediate space without sealing a second portion of the intermediate space. The first portion is located between the process unit and a center of the exhaust fan when viewed in the axial direction. The second portion is located in an opposite side of the center of the exhaust fan from the first portion of the intermediate space when viewed in the axial direction.

In the above structures, the sealing performance for the first duct can be improved and stress applied to the filter can be reduced by the seal. Also, when the gap between the filter and the exhaust fan is under excessive positive pressure, air can flow toward the opposite side opposite to the process unit through the opening. As a result, the likelihood that air containing water vapor flows into the process unit can be reduced.

### BRIEF DESCRIPTION OF DRAWINGS

FIG. 1 is a central cross-sectional view illustrating an image forming apparatus 1.

FIG. 2 is a perspective view illustrating the image forming apparatus 1.

FIG. 3 is a side view illustrating a right side wall 23 of a main body housing 2.

FIG. 4 is an exploded perspective view illustrating a first exhaust fan 71, a second exhaust fan 72, a first exhaust filter 73, and a second exhaust filter 74 which are supported by a right frame 26.

FIG. 5 is a rear cross-sectional view illustrating a first fan duct 27, a second fan duct 28, the first exhaust fan 71, the second exhaust fan 72, the first exhaust filter 73, the second exhaust filter 74, a first louver 24, and a second louver 25.

FIG. 6 is a side view illustrating a control circuit board 13, and seals 76 surrounding the outer peripherals of the first exhaust fan 71 and the second exhaust fan 72, the control circuit board 13 and the seals 76 being supported by the right frame 26.

FIG. 7 is a side view illustrating the first exhaust fan 71, the first fan duct 27, the seal 76, and a grounding spring 75.

FIG. 8 is a rear cross-sectional view illustrating the grounding spring 75 supported by a duct rear wall 27C of the first fan duct 27.

FIG. 9 is a perspective view illustrating the grounding spring 75.

FIG. 10 is a side view illustrating an air intake fan 77 supported by the right frame 26, an air intake duct 264 formed on the right frame 26, and the seals 76 surrounding the outer peripherals of the first exhaust fan 71 and the second exhaust fan 72.

### DESCRIPTION

Hereinafter, an embodiment of the present disclosure will be described while referring to the accompanying drawings.

### Image Forming Apparatus

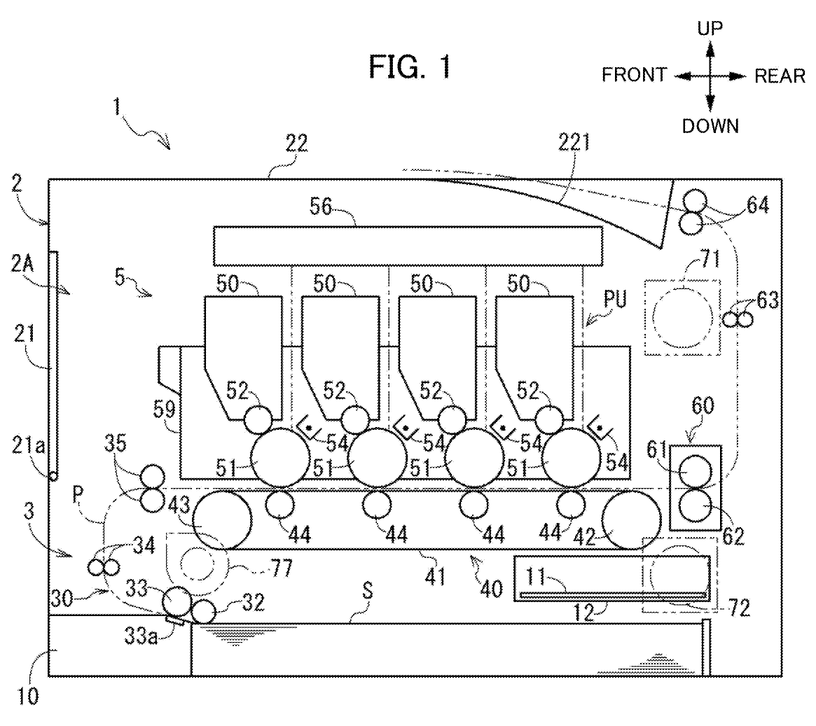

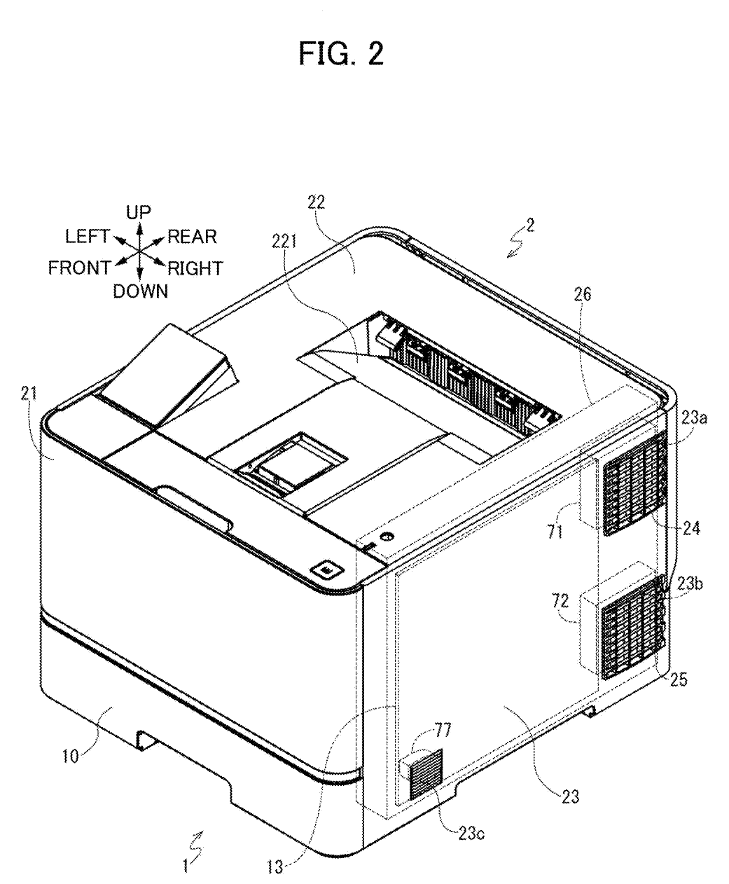

An image forming apparatus 1 illustrated in FIGS. 1 and 2 is an embodiment of the image forming apparatus of the present disclosure. The image forming apparatus 1 is an electrophotographic color laser printer configured to form an image on a sheet S in multiple colors.

In the following description, the left side in FIG. 1 is referred to as the front side of the image forming apparatus 1. The right side in FIG. 1 is referred to as the rear side of the image forming apparatus 1. The side closer to the viewer in FIG. 1 (i.e., the side extending toward the viewer in FIG. 1) is referred to as the right side of the image forming apparatus 1. The side farther from the viewer in FIG. 1 (i.e., the side extending away from the viewer in FIG. 1) is referred to as the left side of the image forming apparatus 1. The upper side in FIG. 1 is referred to as the upper side of the image forming apparatus 1. The lower side in FIG. 1 is referred to as the lower side of the image forming apparatus 1.

The image forming apparatus 1 includes a main body housing 2, a sheet supply section 3, an image forming section 5. The sheet supply section 3 includes a sheet tray 10 configured to support the sheets S and a sheet conveying portion 30 configured to convey the sheets S. The image forming section 5 is configured to form an image on the sheet S conveyed by the sheet supply section 3.

The main body housing 2 has a substantially rectangular parallelepiped shape and accommodates the sheet supply section 3 and the image forming section 5 in the main body housing 2. The main body housing 2 has a front surface opening 2A which opens in the front surface of the main body housing 2. The main body housing 2 includes a front cover 21 configured to open and close the front surface opening 2A.

The front cover 21 includes a pivot shaft 21a at the lower portion of the front cover 21. The front cover 21 is configured to pivotally move about the pivot shaft 21a. Since the front cover 21 pivotally moves about the pivot shaft 21a, the front cover 21 is movable between a closed position at which the front cover 21 closes the front surface opening 2A and an opening position at which the front surface opening 2A opens.

The main body housing 2 includes a top cover 22 disposed at the upper surface of the main body housing 2. The top cover 22 includes a discharge tray 221. The discharge tray 221 slops downward as the discharge tray 221 approaches from the front side toward the rear side.

The sheet supply section 3 is disposed in the lower portion of the main body housing 2. The sheet supply section 3 is configured to convey the sheets S supported on the sheet tray 10 to the image forming section 5 using the sheet conveying portion 30. The sheet tray 10 is configured to slidingly move in a front-rear direction between an accommodated position at which the sheet tray 10 is accommodated in the main body housing 2, and a separated position in which the sheet tray 10 is pulled frontward from the accommodated position.

The sheet conveying portion 30 includes a feeding roller 32, a separating roller 33, a separating pad 33a, a pair of conveying rollers 34, and a pair of registration rollers 35. In the main body housing 2, a conveying path P of the sheet S from the sheet tray 10 to the discharge tray 221 through the image forming section 5 is located.

The sheets S supported on the sheet tray 10 are separated one by one by the feeding roller 32, the separating roller 33, and the separating pad 33a, and then the separated sheet S is conveyed to the conveying path P. The feeding roller 32 is a roller configured to convey the sheet S from the sheet tray 10 toward the image forming section 5. The separating roller 33 and the separating pad 33a constitute a separating mechanism for separating the sheets S supported on the sheet tray 10 one by one.

The sheet S conveyed to the conveying path P is conveyed toward the image forming section 5 by the pair of the conveying rollers 34 and the pair of the registration rollers 35. The pair of the registration rollers 35 is configured to regulate the leading end of the conveyed sheet S to temporarily stop the movement of the sheet S and then convey the sheet S toward the image forming section 5 at a predetermined timing.

The image forming section 5 is disposed above the sheet supply section 3. The image forming section 5 includes four process cartridges 50 arranged in the front-rear direction, and photosensitive drums 51 each of which corresponds to the corresponding one of the four process cartridges 50. Each process cartridge 50 stores a respective one of yellow toner, magenta toner, cyan toner, and black toner. The process cartridges 50 are arranged from the front to the rear in this order of the process cartridge 50 storing yellow toner, the process cartridge 50 storing magenta toner, the process cartridge 50 storing cyan toner, and the process cartridge 50 storing black toner. Each process cartridge 50 includes a developing roller 52.

Each process cartridge 50 is supported by a drawer 59 such that each process cartridge 50 is attachable to and detachable from the drawer 59. Since the front cover 21 moves to the opening position, the drawer 59 can be pulled from the main body housing 2 through the front surface opening 2A of the main body housing 2. The drawer 59 is movable between a first position at which the drawer 59 is positioned inside the main body housing 2 and a second position at which at least part of the drawer 59 positioned outside the main body housing 2.

Each photosensitive drum 51 has a substantially cylindrical shape. An axial direction of the photosensitive drum 51 corresponds to a left-right direction. Each photosensitive drum 51 is rotatably supported by the drawer 59. Each photosensitive drum 51 is rotatable about an axis extending in the left-right direction. That is, each photosensitive drum 51 is configured to rotate about the axis. The left-right direction is an example of the axial direction.

Each developing roller 52 extends in the left-right direction and is rotatably supported by the corresponding process cartridge 50. Toner is an example of the developer. The developing roller 52 of each process cartridge 50 is configured to supply toner to the corresponding photosensitive drum 51. Each process cartridge 50 is an example of the developing unit configured to supply toner to the photosensitive drum.

The main body housing 2 includes an exposure device 56 configured to expose the peripheral surface of each photosensitive drum 51. The exposure device 56 includes a laser diode, a polarizer, a lens, and a mirror. The illustrations of the laser diode, the polarizer, the lens, and the mirror are omitted. The exposure device 56 is configured to emit a light beam to each photosensitive drum 51 to expose the peripheral surface of each photosensitive drum 51.

A transfer belt 41 is disposed below the photosensitive drums 51. The transfer belt 41 faces the photosensitive drums 51 across the conveying path P in the up-down direction. The transfer belt 41 is in contact with the photosensitive drums 51. The transfer belt 41 is looped around a drive roller 42 and a follow roller 43, which is disposed frontward of the drive roller 42. Transfer rollers 44 are disposed such that each transfer roller 44 faces the corresponding one of the photosensitive drums 51. The transfer belt 41 is positioned between the transfer rollers 44 and the photosensitive drums 51. In the image forming section 5, a belt unit 40 includes members including the transfer belt 41, the drive roller 42, the follow roller 43, and the transfer rollers 44.

The image forming section 5 includes chargers 54 each of which is configured to charge the corresponding one of the photosensitive drums 51. The chargers 54 are supported by the drawer 59. The photosensitive drum 51 charged uniformly by the corresponding charger 54 is selectively exposed by the exposure device 56. Since the photosensitive drum 51 is exposed, charge is selectively removed from the peripheral surface of the photosensitive drum 51, thereby forming an electrostatic latent image on the peripheral surface of the photosensitive drum 51.

Toner accommodated in each process cartridge 50 is charged with positive polarity. Each developing roller 52 is configured to carry toner on the peripheral surface of the developing roller 52. Developing bias is applied to the developing rollers 52. When an electrostatic latent image on the peripheral surface of the photosensitive drum 51 faces the corresponding developing roller 52, toner is supplied from the corresponding developing roller 52 to the electrostatic latent image due to an electric potential difference between the electrostatic latent image and the corresponding developing roller 52. Hence, a toner image is formed on the peripheral surface of the photosensitive drum 51.

Upon the sheet S conveyed toward the image forming section 5 reaching the transfer belt 41, the sheet S is conveyed by the transfer belt 41 and sequentially passes the gaps between the transfer belt 41 and the photosensitive drums 51. Then, when a toner image carried on the peripheral surface of the photosensitive drum 51 faces the sheet S, the toner image carried on the peripheral surface of the photosensitive drum 51 is transferred to the sheet S by transfer bias applied to the transfer rollers 44.

In the present embodiment, the transfer belt 41 is configured as a conveying belt for conveying the sheet S, to which a toner image is transferred. However, the transfer belt 41 may be configured as an intermediate transfer belt to which a toner image is transferred and from which the toner image transferred to the transfer belt 41 is then further transferred to the sheet S.

The Sheet S to which a toner image is transferred is conveyed to a fixing device 60. The fixing device 60 includes a heating roller 61, and a pressure roller 62 pressed against the heating roller 61. While the sheet S conveyed to the fixing device 60 passes between the heating roller 61 and the pressure roller 62, the toner image is thermally fixed to the sheet S. That is, the fixing device 60 is configured to heat the sheet S on which a toner image is formed to fix the toner image to the sheet S.

The sheet S to which a toner image is thermally fixed is conveyed downstream in a conveying direction from the fixing device 60. Then, the sheet S is conveyed by a pair of intermediate discharging rollers 63 and a pair of discharging rollers 64 disposed downstream of the pair of the intermediate discharging rollers 63 in the conveying direction. Thereafter, the sheet S is discharged on the discharge tray 221.

In the image forming apparatus 1, a process unit PU includes members including the drawer 59, the process cartridges 50, which are configured to be supported by the drawer 59, the photosensitive drums 51, and the chargers 54. The process unit PU is configured to form a toner image on the sheet S. The process unit PU is an example of the process unit configured to form a toner image on the sheet.

The process unit PU may include the transfer belt 41 or the fixing device 60 as long as the process unit PU includes at least the photosensitive drums 51 and the process cartridges 50. In the process unit PU, the drawer 59 may be configured to support the photosensitive drums 51 as described in the present embodiment. Also, in the process unit PU, each process cartridge 50 may be configured to support the corresponding photosensitive drum 51.

The image forming apparatus 1 includes a power circuit board 11 on which a power circuit is formed and a circuit board cover 12 for covering the power circuit board 11. The power circuit board 11 is an example of the first circuit board. Inside the main body housing 2, the circuit board cover 12 is disposed between the sheet tray 10 and the belt unit 40 in the rear portion of the main body housing 2. The circuit board cover 12 is positioned below the fixing device 60. The main body housing 2 accommodates the process unit PU and the circuit board cover 12 in the main body housing 2.

The image forming apparatus 1 includes a first exhaust fan 71 and a second exhaust fan 72 which are configured to exhaust air inside the main body housing 2 to the outside of the main body housing 2. The first exhaust fan 71 and the second exhaust fan 72 are examples of the exhaust fan configured to exhaust air inside the main body housing.

The first exhaust fan 71 is disposed rightward and rearward of the process unit PU inside the main body housing 2. The first exhaust fan 71 is configured to exhaust air which has passed through the process unit PU and the fixing device 60 inside the main body housing 2 to the outside of the main body housing 2. With this configuration, air which has passed through the process unit PU and the fixing device 60 can be efficiently exhausted by the first exhaust fan 71.

The first exhaust fan 71 is disposed at a position not overlapping the process unit PU when viewed in the left-right direction. The first exhaust fan 71 is positioned above the fixing device 60 when viewed in the left-right direction. Since the first exhaust fan 71 is positioned above the fixing device 60, the first exhaust fan 71 can efficiently exhaust air heated by the fixing device 60 inside the main body housing 2 to the outside of the main body housing 2.

The second exhaust fan 72 is disposed rightward of both the circuit board cover 12 and the power circuit board 11 inside the main body housing 2. The second exhaust fan 72 is disposed at a position overlapping both the circuit board cover 12 and the power circuit board 11 when viewed in the left-right direction. The second exhaust fan 72 is positioned below the first exhaust fan 71. The second exhaust fan 72 is configured to exhaust air inside the circuit board cover 12 in the inside of the main body housing 2 to the outside of the main body housing 2.

The second exhaust fan 72 is disposed at a position not overlapping the process unit PU when viewed in the left-right direction. The second exhaust fan 72 is positioned below the fixing device 60 when viewed in the left-right direction. Since the second exhaust fan 72 is disposed at the position below the fixing device 60 and overlapping the power circuit board 11, the second exhaust fan 72 can efficiently exhaust heat generated in the power circuit board 11 to the outside of the main body housing 2.

As illustrated in FIG. 2, the main body housing 2 accommodates a right frame 26 at the right end portion of the main body housing 2 inside the main body housing 2. The main body housing 2 includes a right side wall 23 covering the right portion of the right frame 26. The right side wall 23 is positioned at the right end portion of the main body housing 2 in the left-right direction. The right side surface of the right side wall 23 is an example of the first side surface located in one end side in the axial direction.

The right side wall 23 has a first opening 23a and a second opening 23b. The first opening 23a and the second opening 23b extend through the right side wall 23 in the left-right direction. The first opening 23a and the second opening 23b are positioned at the rear portion of the right side wall 23. The first opening 23a is positioned above the second opening 23b.

The first exhaust fan 71 is supported by the right frame 26 and is disposed at a position overlapping the first opening 23a when viewed in the left-right direction. Since the first exhaust fan 71 is driven, an airflow in a direction from the left toward the right is generated. Air inside the process unit PU and air in the vicinity of the fixing device 60 are exhausted to the outside of the main body housing 2 through the first opening 23a by the airflow generated by the first exhaust fan 71. The right side wall 23 is disposed downstream of the first exhaust fan 71 in an exhaust direction in which air is exhausted by the first exhaust fan 71.

The second exhaust fan 72 is supported by the right frame 26 and is disposed at a position overlapping the second opening 23b when viewed in the left-right direction. Since the second exhaust fan 72 is driven, an airflow in the direction from the left toward the right is generated. Air inside the circuit board cover 12 is exhausted to the outside of the main body housing 2 through the second opening 23b by the airflow generated by the second exhaust fan 72. The right side wall 23 is disposed downstream of the second exhaust fan 72 in an exhaust direction in which air is exhausted by the second exhaust fan 72.

In the left-right direction, the first exhaust fan 71 and the second exhaust fan 72 are positioned in the side in which the right side wall 23 is positioned inside the main body housing 2. Here, the position in the side in which the right side wall 23 is positioned inside the main body housing 2 refers to the position closer to the right side surface of the right side wall 23 in the left-right direction than the position is to the center in the left-right direction of the inside of the main body housing 2 in the left-right direction. That is, in the axial direction, the exhaust fan is positioned in a side in which the first side surface is located inside the main body housing.

The right side wall 23 has an air intake opening 23c extending through the right side wall 23 in the left-right direction. Air outside the main body housing 2 can flow into the inside of the main body housing 2 through the air intake opening 23c. The image forming apparatus 1 includes an air intake fan 77. The air intake fan 77 is disposed inward of the right side wall 23 and is configured to draw air outside the main body housing 2 into the inside of the main body housing 2. Inside the main body housing 2, the air intake fan 77 is disposed at the right end portion and the front-lower portion of the main body housing 2.

Since the air intake fan 77 is driven, air outside the main body housing 2 is drawn into the inside of the main body housing 2 through the air intake opening 23c. The inside of the main body housing 2 is cooled due to air drawn into the inside of the main body housing 2. As a result, the likelihood that the temperature inside the main body housing 2 rises can be reduced.

A control circuit board 13 is supported by the right side surface of the right frame 26. The control circuit board 13 is configured to control operations of the image forming apparatus 1. The control circuit board 13 is a high-voltage power circuit board configured to apply a high voltage. The control circuit board 13 is configured to apply the developing bias to the developing roller 52, is configured to apply charging bias to each charger 54, and is configured to apply the transfer bias to the transfer rollers 44. The control circuit board 13 is an example of the second circuit board configured to apply a developing bias to the developing roller. The control circuit board 13 is an example of the circuit board configured to apply a developing bias to the developing roller.

The control circuit board 13 is disposed between the right frame 26 and the right side wall 23 in the left-right direction. The control circuit board 13 is positioned in the side in which the right side wall 23 is positioned inside the main body housing 2. That is, in the axial direction, the circuit board is positioned in the side in which the first side surface is located inside the main body housing.

In the front-rear direction, the control circuit board 13 is positioned frontward of the first exhaust fan 71 and the second exhaust fan 72. The control circuit board 13 is disposed at a position not overlapping the first exhaust fan 71 and the second exhaust fan 72 when viewed in the left-right direction. The control circuit board 13 is disposed at a position overlapping the process unit PU when viewed in the left-right direction.

### First Exhaust Fan, First Fan Duct, First Exhaust Filter, and First Louver

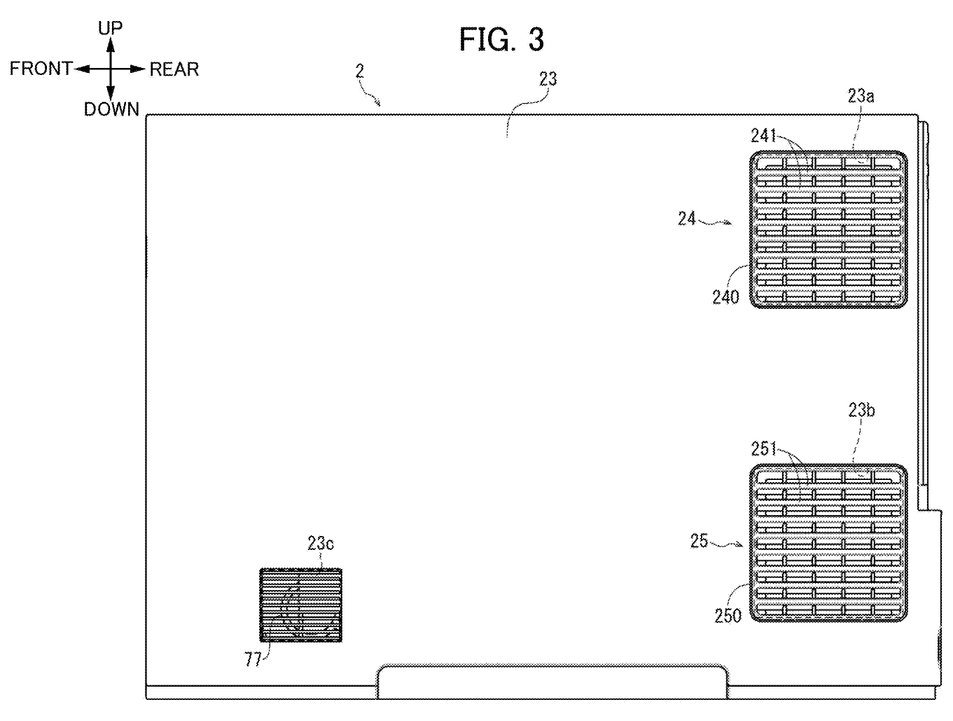

As illustrated in FIGS. 2-5, the right frame 26 includes a first fan duct 27 extending through the right frame 26 in the left-right direction. The first fan duct 27 is an example of the first duct. The first fan duct 27 extends in the left-right direction and allows air to flow in the left-right direction. The first fan duct 27 has a rectangular shape when viewed in the left-right direction. The first exhaust fan 71 is fitted in the first fan duct 27. The first fan duct 27 accommodates the first exhaust fan 71 in the internal space of the first fan duct 27.

The right side wall 23 of the main body housing 2 includes a first louver 24 covering the first opening 23a. The first louver 24 is an example of the louver. The first louver 24 provides a communication between the inside of the main body housing 2 and the outside of the main body housing 2. In the present embodiment, the first louver 24 and the right side wall 23 are integrally molded product. However, the first louver 24 may be configured such that the first louver 24 is attachable to and detachable from the right side wall 23.

The first louver 24 is positioned rightward of the first fan duct 27 and the first exhaust fan 71. That is, in the main body housing 2, the first fan duct 27 and the first exhaust fan 71 are disposed inward of the first louver 24 in the left-right direction.

The first louver 24 has a frame 240 and louver blades 241. The frame 240 has a rectangular shape along the peripheral portion of the right side wall 23 defining the first opening 23a. The louver blades 241 are disposed in the range surrounded by the frame 240. Each louver blade 241 extends in the front-rear direction. The louver blades 241 are arranged in an up-down direction. Each louver blade 241 is sloped upward as the louver blade 241 approaches from the left to the right. Since air flowing from the left to the right passes through the first louver 24, the exhaust direction of air is changed to a right upper oblique direction.

The first fan duct 27 protrudes rightward of the first exhaust fan 71. That is, the right end portion 27F of the first fan duct 27 extends to the gap between the first exhaust fan 71 and the first louver 24 in the left-right direction. In other words, the right end portion 27F of the first fan duct 27 is located closer to the first louver 24 in the left-right direction than the first exhaust fan 71 is to the first louver 24 in the left-right direction.

The image forming apparatus 1 includes a first exhaust filter 73 positioned between the first louver 24 and the first fan duct 27 in the left-right direction. That is, the first exhaust filter 73 is positioned between the first louver 24 and the first exhaust fan 71 in the left-right direction. The first exhaust filter 73 is supported by the right side wall 23. The first exhaust filter 73 is an example of the filter. The first exhaust filter 73 has a rectangular shape when viewed in the left-right direction.

The first exhaust filter 73 has a first surface 73a which is the right side surface of the first exhaust filter 73 and a second surface 73b which is the left side surface of the first exhaust filter 73. The first surface 73a faces the first louver 24 of the right side wall 23. The second surface 73b faces the first fan duct 27 and the first exhaust fan 71.

The first exhaust filter 73 is constituted by a honeycomb filter in which a filter material is shaped into a honeycomb structure, for example. The honeycomb filter, which constitutes the first exhaust filter 73, has multiple cells partitioned by partition walls extending in the left-right direction.

As the filter material, which constitutes the first exhaust filter 73, a paper carrying an activated carbon or an ozone decomposition catalyst such as manganese dioxide, a metal such as aluminum, or a ceramic can be used, for example. The first exhaust filter 73 has a rectangular sheet shape.

Inside the main body housing 2, ozone is generated by members that generate electrical discharge in air such as the charger 54 of the process unit PU. Also, there is a possibility that toner accommodated inside the process cartridge 50 becomes airborne inside the main body housing 2.

Air inside the process unit PU is drawn rearward of the process unit PU by the first exhaust fan 71. Then, the air flows rightward and passes through the first exhaust filter 73. When the air passes through the first exhaust filter 73, dust such as toner is removed from the air. Thereafter, the air is exhausted to the outside of the main body housing 2 through the first louver 24. As a result, dust and the like contained in air which has passed through the process unit PU and is to be exhausted by the first exhaust fan 71 can be reduced.

The first exhaust filter 73 may be any filter as long as at least the first exhaust filter 73 can remove dust such as toner from air. Also, as the first exhaust filter 73, an ozone filter may be used. The ozone filter is configured to collect and remove dust such as toner and is configured to decompose ozone in air.

Since the first exhaust filter 73 is constituted by the ozone filter configured to decompose ozone in air passing through the ozone filter, an amount of ozone contained in air exhausted by the first exhaust fan 71 can be reduced. As a result, the likelihood that ozone generated inside the main body housing 2 is exhausted to the outside of the main body housing 2 can be reduced.

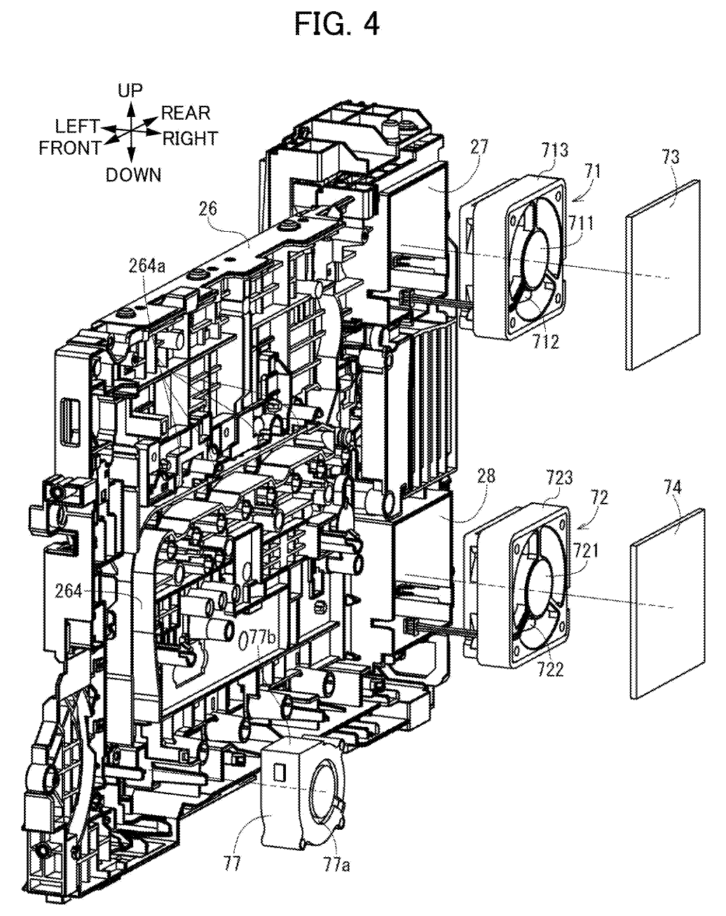

As illustrated in FIGS. 4-6, the first exhaust fan 71 includes a rotational shaft 711 extending in the left-right direction, blades 712 fixed to the rotational shaft 711, and a case 713 supporting the rotational shaft 711 such that the rotational shaft 711 is rotatable. The first exhaust fan 71 is an axial fan configured to blow air in an axial direction of the rotational shaft 711. In the first exhaust fan 71, the case 713 has a rectangular outer shape.

The outer shape of the case 713 defines the outer shape of the first exhaust fan 71. The case 713 protrudes rightward of the blades 712. That is, the right end portion of the case 713 extends to a gap between the blades 712 and the first louver 24 in the left-right direction. In other words, the right end portion of the case 713 is located closer to the first louver 24 in the left-right direction than the blades 712 is to the first louver 24 in the left-right direction.

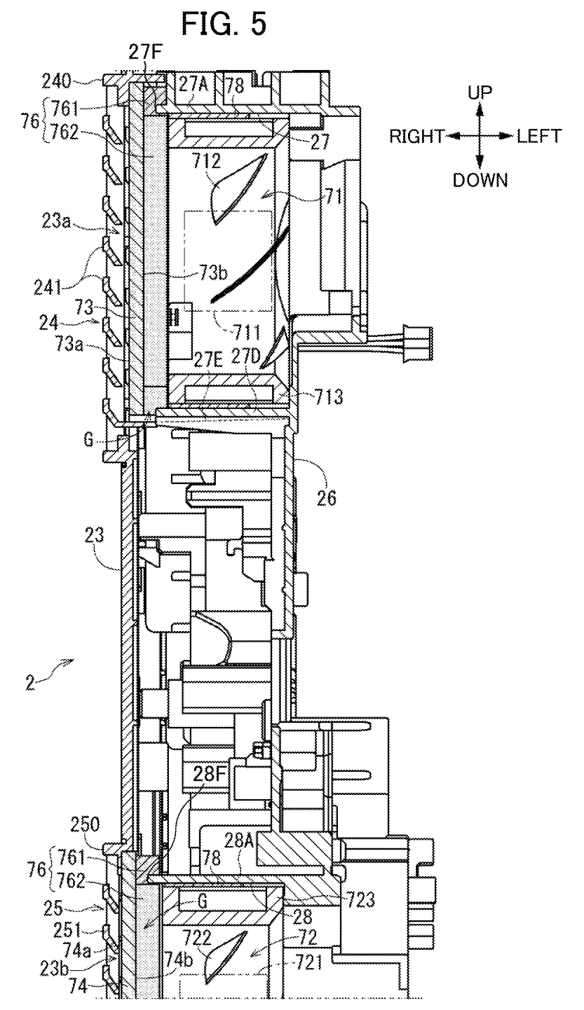

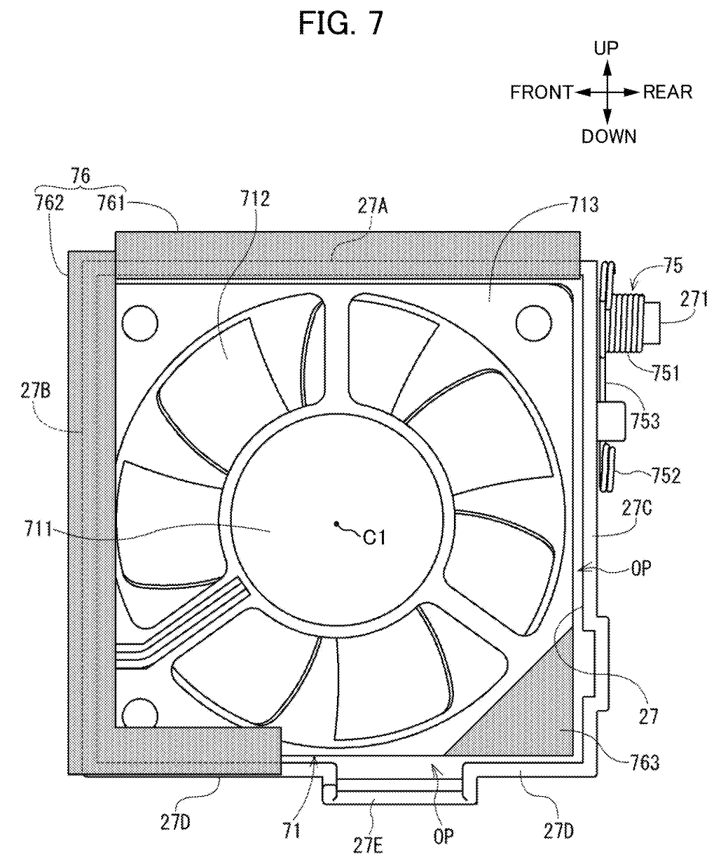

As illustrated in FIGS. 5-7, the first fan duct 27 includes a duct upper wall 27A, a duct front wall 27B, a duct rear wall 27C, a duct lower wall 27D, and a duct bottom wall 27E. The duct upper wall 27A is positioned above the first exhaust fan 71. The duct front wall 27B is positioned frontward of the first exhaust fan 71. The duct rear wall 27C is positioned rearward of the first exhaust fan 71. The duct lower wall 27D and the duct bottom wall 27E are positioned below the first exhaust fan 71.

The peripheral wall of the first fan duct 27 is constituted by the duct upper wall 27A, the duct front wall 27B, the duct rear wall 27C, the duct lower wall 27D and the duct bottom wall 27E. The duct upper wall 27A, the duct front wall 27B, the duct rear wall 27C, and the duct lower wall 27D support the first exhaust fan 71 accommodated in the internal space of the first fan duct 27. The peripheral wall of the first fan duct 27 covers the outer peripheral of the first exhaust fan 71.

The duct bottom wall 27E is formed in the intermediate portion of the duct lower wall 27D in the front-rear direction. The duct bottom wall 27E is recessed downward and is positioned below the duct lower wall 27D. The duct bottom wall 27E extends in the left-right direction. Liquid which has entered inside the main body housing 2 of the image forming apparatus 1 from the upper side of the image forming apparatus 1 is collected on the duct bottom wall 27E and flows rightward along the duct bottom wall 27E. Liquid which flows along the duct bottom wall 27E can be discharged to the outside of the main body housing 2 through the first louver 24.

A cushioning material 78 is disposed between the outer peripheral surface of the case 713 of the first exhaust fan 71 and the inner peripheral surface of the first fan duct 27. The cushioning material 78 closes the gap between the case 713 of the first exhaust fan 71 and the first fan duct 27. The cushioning material 78 is formed of an elastic member. For example, the cushioning material 78 is formed of a sponge having elasticity.

Since the cushioning material 78 is disposed between the outer peripheral surface of the case 713 of the first exhaust fan 71 and the inner peripheral surface of the first fan duct 27 and the cushioning material 78 closes the gap between the case 713 of the first exhaust fan 71 and the first fan duct 27, the likelihood that air to be exhausted by the first exhaust fan 71 leaks through the gap between the first exhaust fan 71 and the first fan duct 27 can be reduced.

### Seal

As illustrated in FIGS. 5-7, a gap G is located between the first fan duct 27 and the first exhaust filter 73 in the left-right direction. Specifically, the gap G is located between the right end portion 27F of the first fan duct 27 and the first exhaust filter 73 in the left-right direction. A seal 76 is disposed on the gap G between the first fan duct 27 and the first exhaust filter 73 in the left-right direction. Specifically, the seal 76 is disposed on the gap G between the right end portion 27F of the first fan duct 27 and the first exhaust filter 73 in the left-right direction. The seal 76 is formed of an elastic member. For example, the seal 76 is formed of a sponge having elasticity.

The seal 76 has a first seal 761, a second seal 762, and a third seal 763. The first seal 761 has a shape extending linearly in the front-rear direction. For example, the first seal 761 has an I-shape. The second seal 762 has an L-shape having a portion extending in the up-down direction and a portion extending rearward from the lower end portion of the portion extending in the up-down direction. The third seal 763 is disposed at the corner portion of the first exhaust fan 71 located in the rear-lower portion of the first exhaust fan 71. The third seal 763 has a triangular shape.

The first seal 761 is disposed between the duct upper wall 27A of the first fan duct 27 and the first exhaust filter 73. The second seal 762 is disposed between the duct front wall 27B of the first fan duct 27 and the first exhaust filter 73, and is disposed between the first exhaust filter 73 and the front portion of the duct lower wall 27D positioned frontward of the duct bottom wall 27E. The third seal 763 is disposed between the first exhaust filter 73 and the corner portion of the first exhaust fan 71, which is located in the rear-lower portion of the first exhaust fan 71.

In the present embodiment, the first seal 761 and the second seal 762 is formed separately in the seal 76. However, the first seal 761 and the second seal 762 may be an integrally formed product. In the present embodiment, each of the first seal 761, the second seal 762, and the third seal 763 is formed of a sponge. However, the first seal 761, the second seal 762, and the third seal 763 are not limited to this configuration. That is, the respective first seal 761, second seal 762, and third seal 763 may each be formed of a different material different from one another. Each of the first seal 761 and the second seal 762 may have an elasticity different from an elasticity of the third seal 763.

In the position in which the seal 76 is disposed between the first fan duct 27 and the first exhaust filter 73, the seal 76 closes the gap G. The seal 76 is in contact with the right end portion 27F of the first fan duct 27 and the second surface 73b of the first exhaust filter 73. In the present embodiment, the seal 76 is not in contact with the case 713 of the first exhaust fan 71. However, the seal 76 may be in contact with the case 713 of the first exhaust fan 71.

The seal 76 surrounds the outer peripheral of the first exhaust fan 71 when viewed in the left-right direction while the seal 76 is disposed between the first exhaust filter 73 and the first fan duct 27. The seal 76 may surround the outer peripherals of the blades 712 of the first exhaust fan 71 when viewed in the left-right direction while the seal 76 is disposed between the case 713 of the first exhaust fan 71 and the first exhaust filter 73.

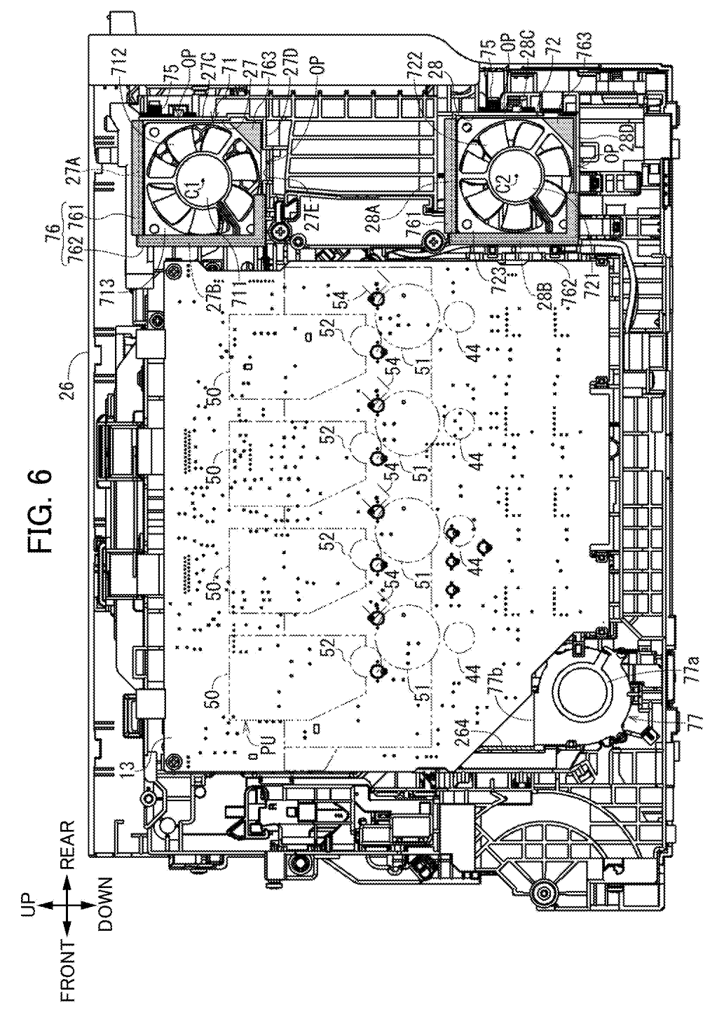

As illustrated in FIG. 6, the passage between a center C1 of the first exhaust fan 71 and the upper side located above the first exhaust fan 71 is blocked by the first seal 761 when viewed in the left-right direction. That is, the first seal 761 is disposed between the center C1 of the first exhaust fan 71 and the upper side located above the first exhaust fan 71 when viewed in the left-right direction. Also, the passage between the center C1 of the first exhaust fan 71 and the process unit PU is blocked by the second seal 762 when viewed in the left-right direction. That is. the second seal 762 is disposed between the center C1 of the first exhaust fan 71 and the process unit PU when viewed in the left-right direction.

The seal 76 is not disposed between the duct rear wall 27C of the first fan duct 27 and the first exhaust filter 73. The seal 76 is not disposed between the duct bottom wall 27E of the first fan duct 27 and the first exhaust filter 73. The seal 76 is not disposed between the first exhaust filter 73 and the rear portion of the duct lower wall 27D positioned rearward of the duct bottom wall 27E in the first fan duct 27.

Openings OP are formed at the portions at which the seal 76 is not disposed. That is, one opening OP is located in the opposite side of the center C1 of the first exhaust fan 71 from the process unit PU when viewed in the left-right direction. The other opening OP is located below the first exhaust fan 71.

Since the seal 76 is in a state where the seal 76 is sandwiched between the first fan duct 27 and the first exhaust filter 73, the seal 76 can seal the gap between the first fan duct 27 and the first exhaust filter 73. In this case, since the seal 76 is formed of an elastic material, the sealing performance for the first fan duct 27 can be improved and stress applied to the first exhaust filter 73 by the seal 76 can be reduced.

Particularly, the seal 76 is formed of a sponge, which is an elastic material. As a result, the sealing performance for the gap between the first exhaust filter 73 and the first fan duct 27 can be improved and stress applied to the first exhaust filter 73 can be effectively reduced.

The sealing performance for the first fan duct 27 is improved. Hence, when the gap between the first exhaust filter 73 and the first exhaust fan 71 is under excessive positive pressure due to air to be exhausted by the first exhaust fan 71, air can flow toward the opposite side opposite to the process unit PU through the opening OP. As a result, when air to be exhausted by the first exhaust fan 71 contains water vapor, the likelihood that the air containing water vapor flows into the process unit PU can be reduced.

The seal 76 is positioned between the first exhaust fan 71 and the control circuit board 13, which is positioned frontward of the first exhaust fan 71, when viewed in the left-right direction. Since the seal 76 is positioned between the first exhaust fan 71 and the control circuit board 13, the likelihood that air to be exhausted by the first exhaust fan 71 flows to the side in which the control circuit board 13 is positioned can be reduced. As a result, when air to be exhausted by the first exhaust fan 71 contains water vapor, the likelihood that the air containing water vapor affects the control circuit board 13 can be reduced.

The duct bottom wall 27E of the first fan duct 27 is positioned below the first exhaust fan 71. The other opening OP is formed in a portion in which the duct bottom wall 27E is positioned, the portion being located below the first exhaust fan 71. That is, the seal 76 has (defines) the other opening OP located below the first exhaust fan 71.

Accordingly, a flow of liquid which has entered inside the main body housing 2 and flows along the duct bottom wall 27E is not blocked by the seal 76. As a result, liquid can be discharged to the outside of the main body housing 2 through the other opening OP, which is located below the first exhaust fan 71.

Also, the seal 76 may be bonded to the first exhaust filter 73, for example. Since the seal 76 and the first exhaust filter 73 are bonded in advance before the first exhaust filter 73 is supported by the right side wall 23, the seal 76 can be disposed between the first exhaust filter 73 and the first fan duct 27 simply by supporting the first exhaust filter 73 on the right side wall 23. As a result, ease of operation in disposing the seal 76 between the first exhaust filter 73 and the first fan duct 27 can be improved.

### Grounding Spring

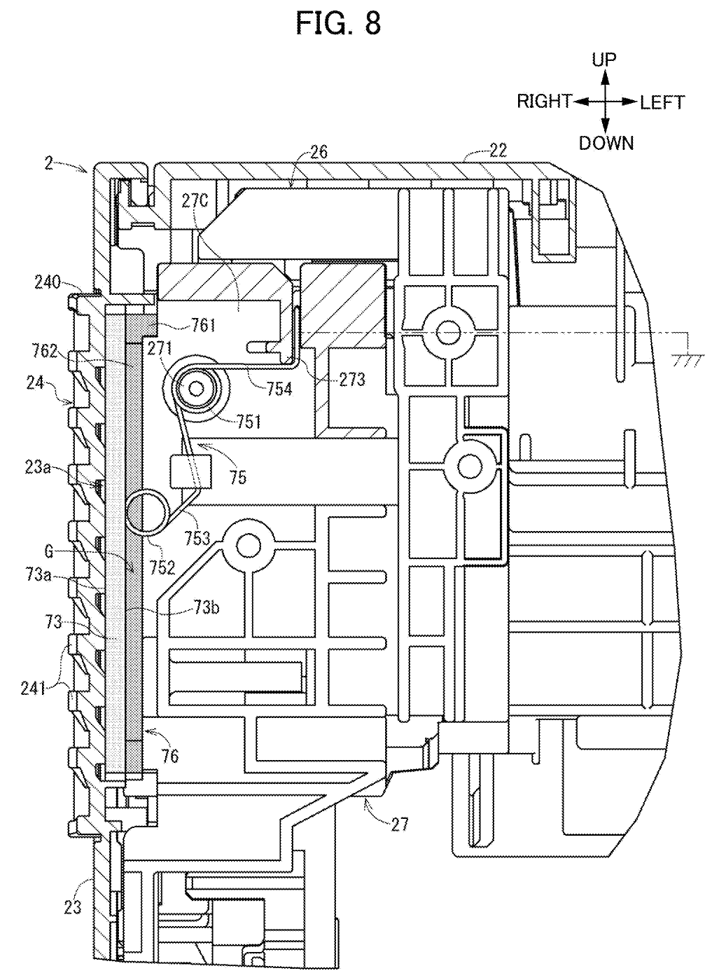

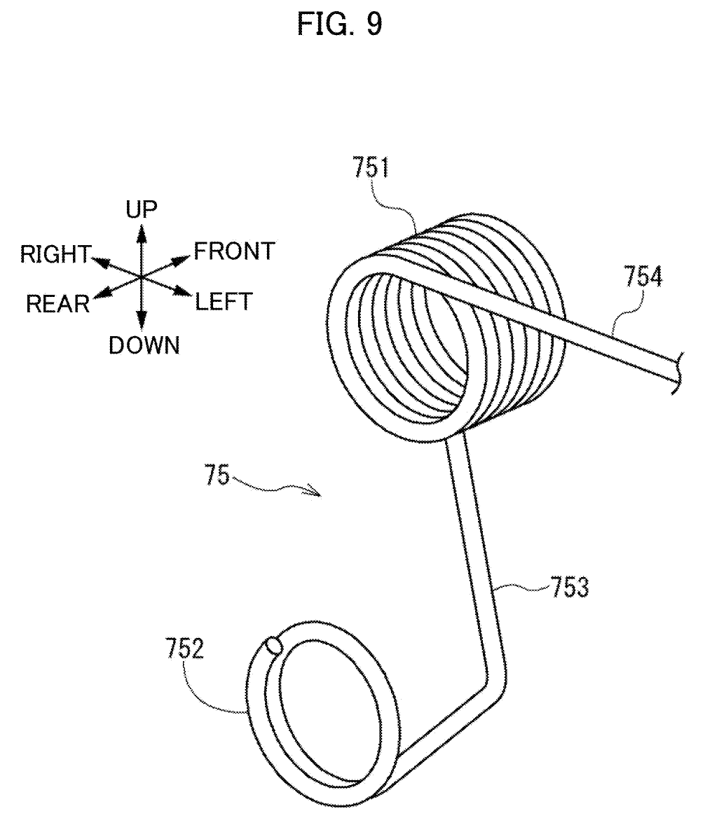

As illustrated in FIGS. 6-9, the image forming apparatus 1 includes a grounded grounding spring 75. The grounding spring 75 is supported on the duct rear wall 27C of the first fan duct 27. The grounding spring 75 is a coil spring formed by winding a wire having electrical conductivity and elasticity.

The grounding spring 75 has a first coil portion 751, a second coil portion 752, a first arm portion 753, and a second arm portion 754. Each of the first coil portion 751 and the second coil portion 752 is formed by winding the wire and has a cylindrical shape. The first arm portion 753 extends from the first coil portion 751, and connects the first coil portion 751 and the second coil portion 752 to each other. The second arm portion 754 extends from the first coil portion 751, and is a different portion from the first arm portion 753. The first arm portion 753 extends from the first coil portion 751 in a direction different from a direction in which the second arm portion 754 extends from the first coil portion 751.

The first fan duct 27 has a boss 271 protruding rearward from the duct rear wall 27C of the first fan duct 27. The first coil portion 751 of the grounding spring 75 is rotatably supported by the boss 271.

The first arm portion 753 extends leftward and downward from the first coil portion 751, and then bends rightward. Thereafter, the first arm portion 753 extends rightward and downward. The second coil portion 752 is connected to the leading end of the first arm portion 753.

The second arm portion 754 extends rearward from the first coil portion 751 and then bends upward. The second arm portion 754 is grounded. For example, since the second arm portion 754 is connected to a metal frame having electrical conductivity of the image forming apparatus 1, the second arm portion 754 is grounded.

The first fan duct 27 has a protrusion 273 protruding rearward and formed at the duct rear wall 27C of the first fan duct 27. The second arm portion 754 of the grounding spring 75 is locked to the protrusion 273 in the lower portion of the protrusion 273.

The grounding spring 75 has an urging force such that the second coil portion 752 moves rightward. The second coil portion 752 is in contact with the second surface 73b of the first exhaust filter 73 by the urging force of the grounding spring 75. The second coil portion 752 is stably pressed against the first exhaust filter 73 by the urging force of the grounding spring 75. The second coil portion 752 presses the first exhaust filter 73 toward the right.

Since the second coil portion 752 is in contact with the second surface 73b of the first exhaust filter 73, the first exhaust filter 73 is grounded. The grounding spring 75 is an example of the grounding member which is in contact with the filter and grounds the filter. Since the first exhaust filter 73 is grounded using the grounding spring 75. the likelihood of accumulation of static charge in the first exhaust filter 73 can be reduced. As a result, the likelihood of electrostatic discharge from the first exhaust filter 73 to other members such as the first exhaust fan 71 can be reduced.

A contact position at which the second coil portion 752 is in contact with the first exhaust filter 73 is in a portion where the one opening OP is formed. That is, the contact position at which the second coil portion 752 is in contact with the first exhaust filter 73 is in the portion overlapping the one opening OP in the left-right direction. That is, the grounding spring 75 is disposed in the portion in which the one opening OP of the seal 76 is formed.

Since the grounding spring 75 is disposed in the portion in which the one opening OP is formed, the first exhaust filter 73 can be grounded using the grounding spring 75 and the grounding spring 75 can press the first exhaust filter 73 in the portion in which the one opening OP is formed. In other words, since the grounding spring 75 is disposed in the portion overlapping the one opening OP in the left-right direction, the first exhaust filter 73 can be grounded using the grounding spring 75 and the grounding spring 75 can press the first exhaust filter 73 in the portion overlapping the one opening OP in the left-right direction.

In the present embodiment, the grounding spring 75 is supported by the duct rear wall 27C of the first fan duct 27. However, the grounding spring 75 may be supported by the portion of the duct lower wall 27D overlapping the portion of the seal 76 in which the other opening OP is formed in the left-right direction. The grounding spring 75 may be supported by the portion of the duct bottom wall 27E overlapping the portion of the seal 76 in which the other opening OP is formed in the left-right direction.

In the present embodiment, the grounding spring 75 is a coil spring and includes the first coil portion 751, the second coil portion 752, the first arm portion 753, and the second arm portion 754. However, the grounding spring 75 is not limited to this configuration. The grounding spring 75 may be formed in various shapes as long as the grounding spring 75 has electrical conductivity and elasticity.

### Second Exhaust Fan, Second Fan Duct, Second Exhaust Filter, and Second Louver

As illustrated in FIGS. 2-5, the right frame 26 includes a second fan duct 28 extending through the right frame 26 in the left-right direction. The second fan duct 28 is an example of the first duct. The second fan duct 28 is positioned below the first fan duct 27. The second fan duct 28 extends in the left-right direction and allows air to flow in the left-right direction. The second fan duct 28 has a rectangular shape when viewed in the left-right direction. The second exhaust fan 72 is fitted in the second fan duct 28. The second fan duct 28 accommodates the second exhaust fan 72 in the internal space of the second fan duct 28.

The right side wall 23 of the main body housing 2 includes a second louver 25 covering the second opening 23b. The second louver 25 is an example of the louver. The second louver 25 provides a communication between the inside of the main body housing 2 and the outside of the main body housing 2. In the present embodiment, the second louver 25 and the right side wall 23 are an integrally molded product. However, the second louver 25 may be configured such that the second louver 25 is attachable to and detachable from the right side wall 23.

The second louver 25 is positioned rightward of the second fan duct 28 and the second exhaust fan 72. That is, inside the main body housing 2, the second fan duct 28 and the second exhaust fan 72 are disposed inward of the second louver 25 in the left-right direction.

The second louver 25 has a frame 250 and louver blades 251. The frame 250 has a rectangular shape along the peripheral portion of the right side wall 23 defining the second opening 23b. The louver blades 251 are disposed in the range surrounded by the frame 250. Each louver blade 251 extends in the front-rear direction. The louver blades 251 are arranged in the up-down direction. Each louver blade 251 is sloped upward as the louver blade 251 approaches from the left to the right. Since air flowing from the left to the right passes through the second louver 25, an exhaust direction of air is changed to a right upper oblique direction.

The second fan duct 28 protrudes rightward of the second exhaust fan 72. That is, the right end portion 28F of the second fan duct 28 extends to the gap between the second exhaust fan 72 and the second louver 25 in the left-right direction. In other words, the right end portion 28F of the second fan duct 28 is located closer to the second louver 25 in the left-right direction than the second exhaust fan 72 is to the second louver 25 in the left-right direction.

The image forming apparatus 1 includes a second exhaust filter 74 positioned between the second louver 25 and the second fan duct 28 in the left-right direction. That is, the second exhaust filter 74 is positioned between the second louver 25 and the second exhaust fan 72 in the left-right direction. The second exhaust filter 74 is supported by the right side wall 23. The second exhaust filter 74 is an example of the filter. The second exhaust filter 74 has a rectangular shape when viewed in the left-right direction.

The second exhaust filter 74 has a first surface 74a which is the right side surface of the second exhaust filter 74 and a second surface 74b which is the left side surface of the second exhaust filter 74. The first surface 74a faces the second louver 25 of the right side wall 23. The second surface 74b faces the second fan duct 28 and the second exhaust fan 72.

The second exhaust filter 74 is constituted by a honeycomb filter in which a filter material is shaped into a honeycomb structure, for example. The honeycomb filter, which constitutes the second exhaust filter 74, has multiple cells partitioned by partition walls extending in the left-right direction.

As the filter material, which constitutes the second exhaust filter 74, a paper carrying an activated carbon or an ozone decomposition catalyst such as manganese dioxide, a metal such as aluminum, or a ceramic can be used, for example. The second exhaust filter 74 has a rectangular sheet shape.

Air inside the circuit board cover 12 accommodated inside the main body housing 2 is heated by electronic components mounted on the power circuit board 11 and thus the temperature of the air is likely to increase. The air inside the circuit board cover 12 flows from the left toward the right by the second exhaust fan 72 and the air passes through the second exhaust filter 74. When the air passes through the second exhaust filter 74, dust and the like are removed from the air. After the removal of the dust and the like, the air is exhausted to the outside of the main body housing 2 through the second louver 25.

Since air inside the circuit board cover 12 is exhausted to the outside of the main body housing 2 by the second exhaust fan 72, the temperature of the air inside the circuit board cover 12 can be decreased. Also, dust and the like contained in air inside the main body housing 2 can be reduced.

The second exhaust filter 74 may be any filter as long as at least the second exhaust filter 74 can remove dust such as toner from air. Also, as the second exhaust filter 74, an ozone filter may be used. The ozone filter is configured to collect and remove dust such as toner and is configured to decompose ozone in air.

The second exhaust fan 72 includes a rotational shaft 721 extending in the left-right direction, blades 722 fixed to the rotational shaft 721, and a case 723 supporting the rotational shaft 721 such that the rotational shaft 721 is rotatable. The second exhaust fan 72 is an axial fan configured to blow air in an axial direction of the rotational shaft 721. In the second exhaust fan 72, the case 723 has a rectangular outer shape.

The outer shape of the case 723 defines the outer shape of the second exhaust fan 72. The case 723 protrudes rightward of the blades 722. That is, the right end portion of the case 723 extends to the gap between the blades 722 and the second louver 25 in the left-right direction. In other words, the right end portion of the case 723 is located closer to the second louver 25 in the left-right direction than the blades 722 is to the second louver 25 in the left-right direction.

As illustrated in FIG. 6, the second fan duct 28 includes a duct upper wall 28A, a duct front wall 28B, a duct rear wall 28C, a duct lower wall 28D. The duct upper wall 28A is positioned above the second exhaust fan 72. The duct front wall 28B is positioned frontward of the second exhaust fan 72. The duct rear wall 28C is positioned rearward of the second exhaust fan 72. The duct lower wall 28D is positioned below the second exhaust fan 72. The second fan duct 28 supports the second exhaust fan 72. The second fan duct 28 covers the outer peripheral of the second exhaust fan 72.

The cushioning material 78 is disposed between the outer peripheral surface of the case 723 of the second exhaust fan 72 and the inner peripheral surface of the second fan duct 28. The cushioning material 78 closes the gap between the case 723 of the second exhaust fan 72 and the second fan duct 28.

In the left-right direction, the gap G is located between the second fan duct 28 and the second exhaust filter 74. Specifically, the gap G is located between the right end portion 28F of the second fan duct 28 and the second exhaust filter 74 in the left-right direction. The seal 76 is disposed on the gap G between the second fan duct 28 and the second exhaust filter 74 in the left-right direction. Specifically, the seal 76 is disposed on the gap G between the right end portion 28F of the second fan duct 28 and the second exhaust filter 74 in the left-right direction.

The seal 76 disposed on the gap G between the second fan duct 28 and the second exhaust filter 74 is formed in the same manner as the seal 76 disposed on the gap G between the first fan duct 27 and the first exhaust filter 73.

That is, as illustrated in FIG. 6, the seal 76 surrounds the outer peripheral of the second exhaust fan 72 when viewed in the left-right direction while the seal 76 is disposed between the second fan duct 28 and the second exhaust filter 74. The seal 76 may surround the outer peripherals of the blades 722 of the second exhaust fan 72 when viewed in the left-right direction while the seal 76 is disposed between the case 723 of the second exhaust fan 72 and the second exhaust filter 74.

The passage between a center C2 of the second exhaust fan 72 and the upper side located above the second exhaust fan 72 is blocked by the first seal 761 when viewed in the left-right direction. That is, the first seal 761 is disposed between the center C2 of the second exhaust fan 72 and the upper side positioned above the second exhaust fan 72 when viewed in the left-right direction. Also, the passage between the center C2 of the second exhaust fan 72 and the process unit PU is blocked by the second seal 762 when viewed in the left-right direction. That is, the second seal 762 is disposed between the center C2 of the second exhaust fan 72 and the process unit PU when viewed in the left-right direction.

The seal 76 is not disposed between the duct rear wall 28C of the second fan duct 28 and the second exhaust filter 74. The seal 76 is not disposed between the rear portion of the duct lower wall 28D of the second fan duct 28 and the second exhaust filter 74. The openings OP are formed at the portions at which the seal 76 is not disposed. That is, the one opening OP is located in the opposite side of the center C2 of the second exhaust fan 72 from the process unit PU when viewed in the left-right direction. The other opening OP is located below the first exhaust fan 71.

Since the seal 76 is in a state where the seal 76 is sandwiched between the second fan duct 28 and the second exhaust filter 74, stress applied to the second exhaust filter 74 can be reduced and the sealing performance for the second fan duct 28 can be improved.

When the gap between the second exhaust filter 74 and the second exhaust fan 72 is under excessive positive pressure due to air to be exhausted by the second exhaust fan 72, air can flow toward the opposite side opposite to the process unit PU through the one opening OP. As a result, when air to be exhausted by the second exhaust fan 72 contains water vapor, the likelihood that the air containing water vapor flows into the process unit PU can be reduced.

The seal 76 is positioned between the second exhaust fan 72 and the control circuit board 13, which is positioned frontward of the second exhaust fan 72, when viewed in the left-right direction. Since the seal 76 is positioned between the second exhaust fan 72 and the control circuit board 13, the likelihood that air to be exhausted by the second exhaust fan 72 flows toward the control circuit board 13 can be reduced. As a result, when the air to be exhausted by the second exhaust fan 72 contains water vapor, the likelihood that the air containing water vapor affects the control circuit board 13 can be reduced.

The grounded grounding spring 75 is supported on the duct rear wall 28C of the second fan duct 28. The grounding spring 75 is disposed in a portion in which the one opening OP of the seal 76 is formed.

Since the second coil portion 752 of the grounding spring 75 is in contact with the second surface 74b of the second exhaust filter 74, the second exhaust filter 74 is pressed rightward by the second coil portion 752. Also, since the second coil portion 752 is in contact with the second exhaust filter 74, the second exhaust filter 74 is grounded.

### Air intake fan and Air Intake Duct

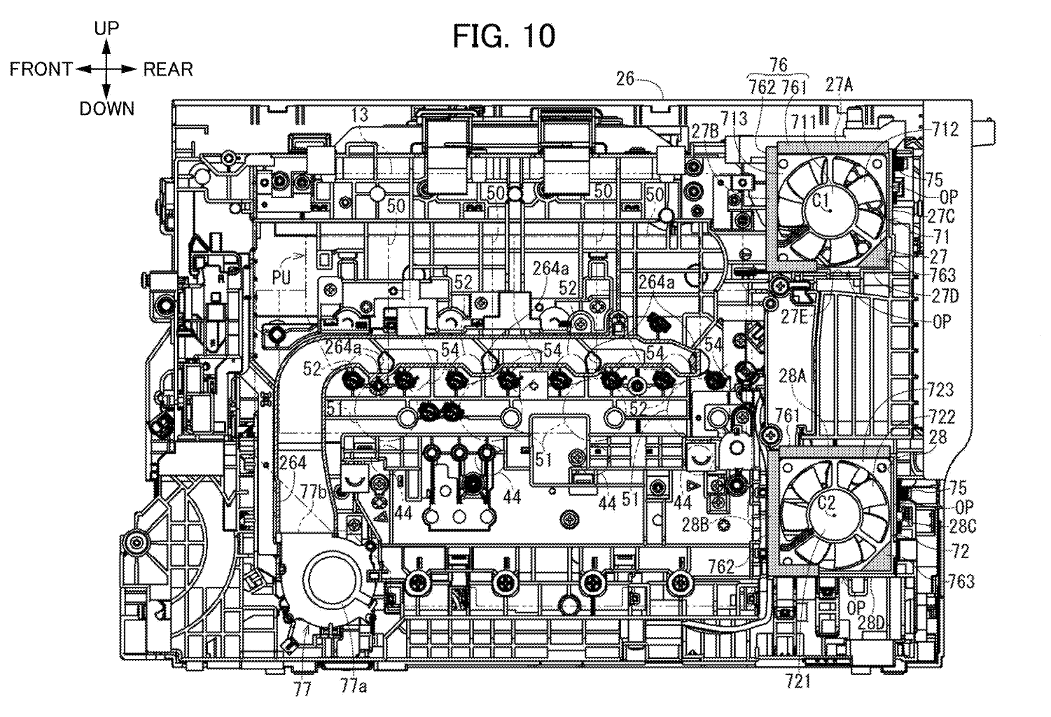

As illustrated in FIGS. 4 and 10, the air intake fan 77 is supported on the right side surface of the right frame 26. For example, the air intake fan 77 is constituted by a centrifugal fan in which air is drawn in the axial direction of the air intake fan 77 and is exhausted in a centrifugal direction orthogonal to the axial direction. The air intake fan 77 is disposed inside the main body housing 2 in such an orientation that the axial direction of the air intake fan 77 corresponds to the left-right direction. Air outside the main body housing 2 is drawn into the inside of the main body housing 2 by the air intake fan 77 through the air intake opening 23c.

The air intake fan 77 has an air intake portion 77a configured to draw air and an air exhaust portion 77b configured to exhaust air. The air intake portion 77a faces the air intake opening 23c of the right side wall 23. The air exhaust portion 77b is located in the upper end portion of the air intake fan 77 and is configured to exhaust air upward.

An air intake duct 264 is formed on the right side surface of the right frame 26. The air intake duct 264 is an example of the second duct. The air intake duct 264 is an air intake passage configured to guide air drawn by the air intake fan 77 to the process unit PU. The air intake duct 264 extends upward from the air exhaust portion 77b, and then extends rearward.

Four air intake holes 264a are formed in the portion of the right frame 26 in which the air intake duct 264 is formed. The air intake holes 264a extend through the right frame 26 in the left-right direction. Each of the air intake holes 264a is formed at the portion corresponding to the corresponding one of the process cartridges 50, which are arranged in the front-rear direction, and corresponding to the corresponding one of the photosensitive drums 51, which are arranged in the front-rear direction.

Air drawn from the outside of the main body housing 2 by the air intake fan 77 is guided by the air intake duct 264 along the right side surface of the right frame 26. Then, the air is discharged to the left through the air intake holes 264a. Thereafter, the air discharged to the left through the air intake holes 264a reaches the process unit PU, which is positioned inward of the right frame 26 inside the main body housing 2. As described above, the air intake duct 264 is configured to guide air drawn by the air intake fan 77 to the process unit PU in the left-right direction.

In a case where air which has passed through the process unit PU is exhausted by the first exhaust fan 71, a space in which the process unit PU is accommodated inside the main body housing 2 tends to become negative pressure. In this case, when the space in which the process unit PU is accommodated becomes excessively negative in pressure, there is a likelihood that air to be exhausted by the first exhaust fan 71 leaks between the first exhaust filter 73 and the first fan duct 27, and flows into the side in which the process unit PU is positioned.

Accordingly, since the air intake duct 264 is configured to guide air drawn by the air intake fan 77 to the process unit PU. the likelihood that the space in which the process unit PU is accommodated becomes excessively negative in pressure can be reduced. As a result, the likelihood that air to be exhausted by the first exhaust fan 71 flows toward the process unit PU can be reduced.

Also, in a case where the air intake fan 77 is disposed on the right frame 26 and the seal 76 is not disposed between the first exhaust filter 73 and the first fan duct 27, there is a likelihood that air to be exhausted by the first exhaust fan 71 is drawn by the air intake fan 77 through the gap between the right frame 26 and the right side wall 23.

In a case where air to be exhausted by the first exhaust fan 71 is air heated by the fixing device 60, when the heated air is guided to the process unit PU by the air intake fan 77, the heated air causes the temperature of the space, in which the process unit PU is accommodated, to increase inside the main body housing 2. Also, when air to be exhausted by the first exhaust fan 71 contains water vapor, there is a likelihood that the air containing water vapor affects the control circuit board 13, which is a high-voltage circuit board.

However, in the image forming apparatus 1, the seal 76 is positioned between the first exhaust fan 71 and the control circuit board 13, which is positioned frontward of the first exhaust fan 71, while the seal 76 is in a state where the seal 76 is sandwiched between the first fan duct 27 and the first exhaust filter 73.

Accordingly, the likelihood that air to be exhausted by the first exhaust fan 71 flows toward the control circuit board 13 can be reduced. Further, the likelihood that air to be exhausted by the first exhaust fan 71 reaches the air intake fan 77, which is positioned frontward and downward of the control circuit board 13 can be reduced. As a result, the likelihood that the temperature of the space in which the process unit PU is accommodated increases inside the main body housing 2 can be reduced, and the likelihood that the air containing water vapor affects the control circuit board 13 can be reduced.

A sealing member surrounding the outer peripheral of the air intake portion 77a and the outer peripheral of the portion of the right side wall 23 defining the air intake opening 23c may be disposed between the air intake fan 77 and the right side wall 23 to reduce the likelihood that air to be exhausted by the first exhaust fan 71 is drawn by the air intake fan 77. In this case, as the sealing member surrounding the outer peripheral of the air intake portion 77a and the outer peripheral of the portion of the right side wall 23 defining the air intake opening 23c, an elastic member such as the sponge may be used, similarly to the seal 76.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiment of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. An image forming apparatus comprising:
a main body housing including a louver;
a process unit configured to form a toner image on a sheet, the process unit including:
a photosensitive drum configured to rotate about an axis; and
a developing unit configured to supply toner to the photosensitive drum;
a fixing device configured to heat the sheet on which the toner image is formed to fix the toner image to the sheet;
an exhaust fan configured to exhaust air inside the main body housing to an outside of the main body housing through the louver, the exhaust fan being disposed inside the main body housing, the exhaust fan being positioned inward of the louver in an axial direction of the photosensitive drum, the exhaust fan being disposed at a position not overlapping the process unit when viewed in the axial direction;
a first duct extending in the axial direction to have an end portion located closer to the louver in the axial direction than the exhaust fan is to the louver in the axial direction, the first duct accommodating the exhaust fan in an internal space of the first duct;
a filter disposed between the louver and the end portion of the first duct in the axial direction; and
a seal formed of an elastic material, the seal being sandwiched between the end portion of the first duct and the filter in the axial direction, the seal surrounding the exhaust fan when viewed in the axial direction, the seal blocking a passage between the process unit and a center of the exhaust fan when viewed in the axial direction, the seal defining an opening located in an opposite side of the center of the exhaust fan from the process unit when viewed in the axial direction.

2. The image forming apparatus according to claim 1,
wherein the exhaust fan is positioned above the fixing device when viewed in the axial direction.

3. The image forming apparatus according to claim 1, further comprising:
a first circuit board disposed at a position overlapping the exhaust fan when viewed in the axial direction,
wherein the exhaust fan is positioned below the fixing device when viewed in the axial direction.

4. The image forming apparatus according to claim 1,
wherein the seal defines another opening located below the exhaust fan.

5. The image forming apparatus according to claim 1, further comprising:
a grounding member in contact with the filter to ground the filter, the grounding member being disposed in a portion of the first duct, the portion overlapping the opening of the seal in the axial direction.

6. The image forming apparatus according to claim 1, further comprising:
a circuit board positioned inside the main body housing,
wherein the process unit includes a developing roller,
wherein the main body housing has:
a first side surface located at one end portion of the main body housing in the axial direction,
wherein the exhaust fan is positioned closer to the first side surface in the axial direction than the exhaust fan is to the center in the axial direction of an inside of the main body housing in the axial direction,
wherein the circuit board is configured to apply a developing bias to the developing roller, and
wherein the circuit board is positioned closer to the first side surface in the axial direction than the circuit board is to the center in the axial direction of the inside of the main body housing in the axial direction, the circuit board being disposed at a position overlapping the process unit when viewed in the axial direction, the circuit board being disposed at a position not overlapping the exhaust fan when viewed in the axial direction.

7. The image forming apparatus according to claim 1,
wherein the elastic material is a sponge.

8. The image forming apparatus according to claim 1, further comprising:
an air intake fan configured to draw air into the main body housing; and
a second duct configured to guide air drawn by the air intake fan toward the process unit in the axial direction.

9. The image forming apparatus according to claim 1,
wherein the process unit includes a charger configured to charge the photosensitive drum, and
wherein the filter is an ozone filter configured to decompose ozone contained in air passing through the ozone filter.

10. An image forming apparatus comprising:
a main body housing including a louver;
a process unit configured to form a toner image on a sheet, the process unit including:
a photosensitive drum configured to rotate about an axis extending in an axial direction; and
a developing roller configured to supply toner to the photosensitive drum;
a fixing device configured to heat the sheet on which the toner image is formed to fix the toner image to the sheet;
an exhaust fan configured to exhaust air from an inside of the main body housing to an outside of the main body housing through the louver, the exhaust fan being disposed inside the main body housing, the exhaust fan being positioned inward of the louver in the axial direction, the exhaust fan being disposed at a position not overlapping the process unit when viewed in the axial direction;
a first duct disposed inside the main body housing, the first duct accommodating the exhaust fan in an internal space of the first duct, the first duct extending in the axial direction to have an end portion located closer to the louver in the axial direction than the exhaust fan is to the louver in the axial direction;
a filter disposed between the louver and the end portion of the first duct in the axial direction with an intermediate space formed between the filter and the end portion of the first duct in the axial direction, the intermediate space surrounding the exhaust fan when viewed in the axial direction; and
a seal formed of an elastic material, the seal being sandwiched between the filter and the end portion of the first duct in the axial direction, the seal surrounding the exhaust fan when viewed in the axial direction, the seal sealing at least a first portion of the intermediate space without sealing a second portion of the intermediate space, the first portion being located between the process unit and a center of the exhaust fan when viewed in the axial direction, the second portion being located in an opposite side of the center of the exhaust fan from the first portion of the intermediate space when viewed in the axial direction.
